(19) United States
(12) Patent Application Publication
(10) Pub. No.: US 2007/0098857 A1
(43) Pub. Date: May 3, 2007

(54) Method and device for determining physical characteristics

(75) Inventor: Peter Kohlstrung, Kaufering (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Rational AG, Landsberg/Lech (DE)

(21) Appl. No.: 10/558,233

(22) PCT Filed: May 6, 2004
(86) PCT No.: PCT/DE04/00954

§ 371 Date: Oct. 23, 2006

(30) Foreign Application Priority Data
May 26, 2003 (DE) 103 23 651.1

(51) Int. Cl. A23L 1/01

(52) U.S. Cl. 426/233

(57) ABSTRACT

A method for determining at least one physical characteristic in a product to be cooked, such as in a product to be cooked used in a cooking process, is characterized by the following steps: generating a temporal, changeable temperature field within a product to be cooked; acquiring a plurality of first measured values in the product to be cooked, said first measured values comprising at least one first temperature value at a first position and at least one second temperature value at a second position separated from the first position, and determining the physical characteristic from the first measured values.

### RELATED APPLICATIONS

This is the U.S. national phase of International Application No. PCT/DE2004/000954 filed May 6, 2004, the entire disclosure of which is incorporated herein by reference, and which claims priority to German patent application number 103 23 651.1 filed May 26, 2003.

### TECHNICAL FIELD

The present application concerns a method and device for determination of at least one physical property in a product to be cooked.

### BACKGROUND ART

Methods for controlling a cooking process and a cooking process sensor usable for this purpose are known from DE 199 45 021 A1. It is proposed in this method that several temperature values, preferably four, be recorded within a cooking product at different insertion depths and at least one additional temperature value outside of the cooking product, preferably on the cooking product surface, by means of the cooking process sensor and used to control the cooking process. It is essential for the known method that the core temperature of the cooking product can be precisely determined from the thermokinetics, i.e. from the time trend of the temperature values recorded in the cooking product by means of the cooking process sensor, even with inexact positioning of the cooking process sensor. It is also proposed according to DE 199 45 021 A1 that other climate parameters, like moisture values, moisture difference values and/or air movement values also be recordable, by means of which specific cooking product quantities, like cooking product type and/or thermal conductivity of the cooking product are determined, preferably by extrapolation or iteration via the values recorded by the cooking process sensor. This method and the cooking process sensor usable to perform it have essentially worked. However, it has turned out that, in determination of the thermal conductivity as well as the type of cooking product, there is still a need for improvement. This is attributed, in particular, to the fact that the temperature fluctuations, which reach the cooking product in uncontrolled fashion from the outside, can influence the measurements so that sufficiently precise determination of the specific cooking product quantities is adversely affected.

A method and device for thermal conductivity determination in variable temperature fields is known from DE 42 30 677 A1, in which measurement probes are used, which can be designed as a thin tube in which a heating element is situated, different heat powers being supplied to heating elements of the measurement probes during a measurement process so that the thermal conductivity can be determined during the measurement process from the temperature trend at all measurement sites.

Determination of the moisture content, for example, of foods, as a function of a thermal response, is also known from U.S. Pat. No. 5,257,532. U.S. Pat. No. 6,169,965 B1 concerns a method as well as a device for use of a common frequency generator to measure selected properties of a fluid via at least one heating and/or sensing element. A method and device for measurement of moisture content of the ground by insertion of a sensor into the ground is described in GB 2 198 238 A, in which the sensor has an electric heating element that builds up a temperature gradient within the ground.

A fork-like temperature sensor as a kitchen utensil is known from U.S. 2002/0073853 A1.

### SUMMARY OF THE DISCLOSURE

The task of the present disclosure is therefore to provide a method that overcomes the drawbacks of the prior art, especially that makes possible a simple and precise determination of physical characteristics, like cooking product quantities, with reduced or essentially no effect from outside of the product to be cooked.

This task is solved by a method for determination of a least one physical property in a product to be cooked with the following steps:
generation of a time-variable temperature field within the product to be cooked;
acquiring of a plurality of first measured values in the product to be cooked, in which the first measured values comprise at least a first temperature value at one position and at least a second temperature value at a second position separate from the first position;
picking-up of at least a second measured value in and/or at the product to be cooked, chosen from thermodynamic physical properties, like a moisture value, electrical physical properties, like electrical conductivity, elastic physical properties, like an elastic constant, and/or optical physical properties, like a light-scattering capability; and
determination of at least a first physical property in the form of a susceptibility, like an elastic susceptibility, thermal diffusivity and/or specific thermal conductivity, and a second physical property, chosen from a substance class and/or at least a specific substance quantity, from the first and second measured values.

It can then be prescribed in particular that a predetermined amount of heat be supplied and/or withdrawn to or from the product to be cooked at a third position to generate the time-variable temperature field.

For the aforementioned alternative it is proposed that supply and/or withdrawal of the amount of heat occur periodically, preferably heat is supplied to and withdrawn from the product to be cooked in alternation.

Additional advantageous variants of the disclosed method can be characterized by the fact that a predetermined temperature jump is produced at the third position to produce the time-variable temperature field.

In the three aforementioned alternatives it can be prescribed in particular that the first or second position be identical to the third position.

It is proposed that the disclosed method be characterized by the fact that by means of the first measured value the amplitude response and/or phase position of at least one temperature wave produced by the time-variable temperature field is or are determined at the first and second position.

It is also proposed that by means of the first physical property and/or the second measured value at least a second physical property be determined, the second physical property preferably being chosen from a physical class, like a type of product to be cooked and/or at least a specific physical quantity, like a core temperature of the product to be cooked, a geometry of the product to be cooked, a density of the product to be cooked, a degree of ripening of the product to be cooked, a pH value of the product to be cooked, a consistency of the product to be cooked, a storage condition of the product to be cooked, a browning of the product to be cooked, a crust formation of the product to be cooked, a vitamin degradation of the product to be cooked, formation of carcinogenic substances in the product to be cooked, an endpoint of a process and/or an energy consumption during a process, especially to make a heating trend prediction and/or control the course of a process, like a cooking process.

It is then preferred that the second physical property be determined by extrapolation or iteration of the time trend in the first physical property and/or the second measured value and/or by comparison of the first physical property and/or the second measured value with at least temporarily-stored comparison values.

In the last-named alternative it is proposed that at least one comparison value be stored at least temporarily during and/or after generation of the time-variable temperature field.

It can also be proposed that the first-and/or the second measured value(s) and/or the first and/or the second physical property be fed to at least one control device for at least one heat flow source, at least one heating and/or cooling element interacting with a cooking space, at least one fan, at least one device for introduction of moisture to the cooking space and/or at least one device to remove moisture from the cooking space, especially to control the cooking process and/or to achieve a predetermined cooking result, preferably by controlling the temperature trend, moisture content and/or air movement in the cooking space.

In addition, an expression of the method is proposed with the method in which the first and/or the second measured value(s) is acquired by means of a cooking process sensor at least partially insertable into the product to be cooked and/or the time-variable temperature field is produced by means of at least on heat flow source comprised by the cooking process sensor.

Finally, a device, in the form of a cooking process sensor for determination of at least one physical property in a product to be cooked in a method is furnished, which comprises a shaft that can be introduced at least partially into the cooking product, preferably via a handle, in which the shaft includes at least one first temperature sensor arranged on a first site corresponding to the first position and at least a second temperature sensor arranged at a second site corresponding to the second position, as well as at least one heat flow source arranged at the third site corresponding to the third position.

In addition, it can also be prescribed that the distance between the first, second and/or third site be less than the geometric length of a temperature wave produced within a product to be cooked by the time-variable temperature field.

An advantageous variant proposes that heat conduction between the first, second and/or third site be at least partially reduced over the shaft, preferably at least one region of the shaft between the first, second and/or third site including at least partially a material with lower thermal conductivity than the product to be cooked.

It is also proposed that the shaft have a fork-like free end, in which the first site is arranged in a first prong of the fork and the second site in a second prong of the fork.

It can then be prescribed in particular that the third site be arranged in the first, second and/or third prong of the fork.

An advantageous embodiment of the device proposes that the heat flow source comprises at least one device to supply heat energy, as in the form of an electric heating device and/or a device for conduction of a heating fluid, especially in the form of combustion gases, air, water, and/or the like, and/or a device to take off heat energy, as in the form of at least one Peltier element and/or at least one device for conduction of a cooling fluid, especially in the form of air, water, nitrogen and/or the like.

In particular, a device can be characterized by at least one sensor unit to pick-up the second measured value in effective connection with the device, especially comprised by it.

At least one evaluation, control and/or regulation unit connectable to the device and enclosed by a cooking appliance for production, preparation and/or cooking of foods can also be provided, in which the evaluation, control and/or regulation unit is preferably connectable to a memory unit.

Finally, it is proposed that the device be designed as an integral component of a cooking appliance or as a portable hand-held device.

The advantage is therefore based on the surprising finding that by producing temperature variations within a product to be cooked, and acquiring the propagation of the wave-like temperature field produced within the product to be cooked because of these temperature variations in at least two sites within the product to be cooked separate from each other, a determination of the physical properties, especially in the form of specific cooking product quantities, like specific thermal conductivity and thermal diffusivity of the product to be cooked, is made possible. This determination permits an almost unquestionable assignment of the product to be cooked as a type of product to be cooked.

In principle, products to be cooked or substances differ in a number of properties. The more properties of a product to be cooked or substance are known, the more precisely a conclusion can be made concerning the type of substance, i.e. the substance class. In the case of a product to be cooked, the type of substance being determined, however, can be reduced to a few classes, for example, to foods or only different types of meat, so that a few physical properties are sufficient in order to select the type of product to be cooked from a known class.

In addition to the described determination of specific thermal conductivity and thermal diffusivity of the product to be cooked, additional optical, chemical, elastic and/or electrical material properties can be acquired in order to verify any performed class assignment, especially cooking product determination. In principle, however, the determination of these two specific cooking product quantities is sufficient for determination of the type of product to be cooked.

By comparison of the physical properties determined according to the disclosed method with values entered in a memory, in particular, it is possible to determine the type of product to be cooked almost free of doubt. In addition, the disclosed method and device makes it possible to recognize changes in physical properties during a cooking process and therefore the degree of conversion in the substance. In addition, by means of specific thermal cooking product quantities determined during a cooking process, which determine the heating trend of a substance decisively, in addition to geometry, a prediction of certain states during a cooking process is significantly improved.

Finally, it can be prescribed that the employed device be capable of learning. This means that, if specific cooking product quantities are determined via the disclosed method, which cannot be clearly assigned to a specific type of product to be cooked, the type of product to be cooked can be entered by the user so that a determination of the type of product to be cooked free of doubt and therefore the quality of a cooking process results can be improved for a later cooking process.

### BRIEF DESCRIPTION OF THE DRAWINGS

Additional features and advantages are apparent from the following description, in which the disclosed method is explained by means of preferred variants of the disclosed device with reference to the schematic drawings. In the drawings:

FIG. 1 shows a cross-sectional view of a first variant of a cooking process sensor usable in a disclosed method;

FIG. 2 shows a detailed view of the cooking process sensor of FIG. 1; and

FIG. 3 shows a partial cross-sectional view of a second variant of a cooking process sensor usable in a disclosed method.

### DETAILED DESCRIPTION

shows a cooking process sensor 1, which can be used in the disclosed method. The cooking process sensor 1 includes a shaft 3, which can be inserted at least partially via a handle 5 into a cooking product (not shown), namely at least in the region of its tip 7. The design of the fork-like tip 7 is explained more precisely with reference to FIG. 2. A bundle of conductors 9 passes within shaft 3 for connection with the internals of the cooking process sensor 1 present in tip 7 to an evaluation, control and/or regulation device (not shown). This is passed through handle 5 and is connected to a connection line 11 of the cooking process sensor 1.

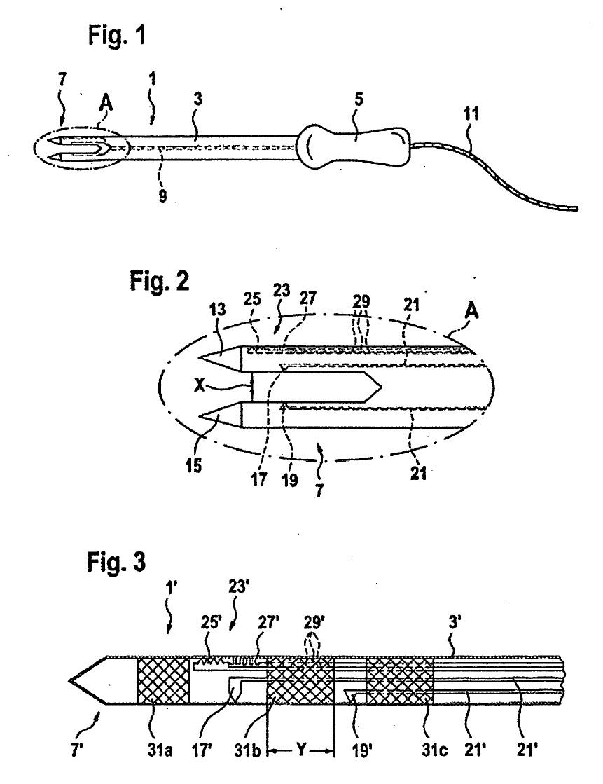

FIG. 2 shows a detailed view of the tip 7 of the cooking process sensor 1 of FIG. 1 according to cut-out A. As can be deduced from FIG. 2, the fork-like tip 7 of cooking process sensor 1 has two prongs 13 and 15. The prongs 13, 15 are spaced from each other by distance X. At a first location of the cooking process sensor 1, in the first prong 13, a first temperature sensor 17 is arranged, whereas at a second location within cooking process sensor 1 in second prong 15 a second temperature sensor 19 is arranged. The temperature sensors 17, 19 are connected to the conductor bundle 9 via lines 21. Moreover, a heat flow source 23 is present at a third site within cooking process sensor 1 on the first prong 13. The heat flow source 23 includes a device 25 to supply heat energy to the cooking product, in which the tip 7 of the cooking process sensor 1 is situated, and a device 27 to remove heat energy from the cooking product. The devices 25, 27 are connected via lines 29 to the conductor bundle 9. The device 25 preferably includes an electric heating device, whereas the device 27 preferably includes a Peltier element.

A method is explained below by means of cooking process sensor 1:

At the beginning of a cooking process, the cooking process sensor 1 is at least partially inserted into a product to be cooked. After introduction of tip 7 of the cooking process sensor 1 into the product to be cooked, the first temperature sensor 17 arrives at a first position, the second temperature sensor 19 at a second position and the heat flow source 23 at a third position within the product to be cooked. Based on the arrangement of the temperature sensor 17, 19 within the fork-like tip 7 of the cooking process sensor 1 depicted in FIG. 2, the temperature measurement sites at temperature sensor 17, 19 are positioned at a defined spacing X within the product to be cooked.

To determine the type of product to be cooked, heat energy is then supplied by means of heat flow source 23 to the product to be cooked via device 25 and heat energy taken off via device 27. This is repeated over a certain period so that a time-variable temperature difference is produced within the product to be cooked via heat flow source 23, i.e. a temperature fluctuation, which propagates in the form of a temperature wave in the product to be cooked. This propagation of the temperature fluctuation produced in the product to be cooked via the heat flow source 23 can be recorded in the form of temperature changes over time via temperature sensors 17, 19. Since the temperature sensors 17, 19 are situated at two different positions within the product to be cooked, especially at different spacings relative to the heat flow source 23, a phase shift and an amplitude ratio of the temperature waves, which differ from each other for different types of products to be cooked, can be determined via the time trend of the temperature values recorded via temperature sensors 17, 19. In order to permit sufficiently precise determination of the phase shifts and amplitude ratios for determination of the type of product to be cooked, the spacing X between temperature sensors 17, 19 should be shorter than the geometric length of a temperature wave produced in the product to be cooked by the temperature fluctuations. The arrangement of the temperature sensors 17, 19 in the prongs of tip 7 of the cooking process sensor 1 reduces the interference effects from the cooking process sensor 1. In addition, at least the surface material of tip 7 of cooking process sensor 1 is preferably chosen so that the thermal conductivity of the surface of the tip 7 is lower than that of the surrounding product to be cooked so that a disturbance of the temperature wave field, which might adversely affect evaluation of the recorded measured value, cannot occur. In particular, it can be prescribed that one of the two temperature sensors be arranged in the heat flow source in contrast to the variant depicted in FIG. 2.

To produce a temperature variation within the product to be cooked, for example, it is prescribed that the heat flow source 23 supply heat energy at fixed time intervals to the product to be cooked via device 25 and/or remove heat energy via device 27. During production of the heat fluctuations resulting from this within the product to be cooked, the temperature values recorded by the temperature sensors 17, 19 are sent by lines 21, 9, 11 to an evaluation unit (not shown) in which the recorded temperature trends are temporarily stored and analyzed. During analysis the specific thermal conductivity X and the thermal diffusivity “a” of the product to be cooked are initially determined. During determination of these specific cooking product quantities it is assumed that analogies exist between propagation of temperature waves in a medium and propagation of electrical or magnetic waves. The electrical impedance of a medium is defined by
Z={square root over ((R²+(ωL−1/(ω*C))²)},
with R=resistance,
ω=angular frequency,
L=inductance, and
C=capacitance.
   If the electrical quantities resistance “R” and capacitance “C” are replaced by their thermal correspondents, namely D/(λ*A), with D=thickness of layer and A=area of the layer, as heat resistance and m*p*cₚ, with m=weight of the layer, ρ=density of the layer and cₚ=specific heat of the layer, as heat capacity, and the inductance “L” is set at zero, the following imaginary model can be set up.

A product to be cooked can be described by thermal masses in which the entire heat capacity is bundled, a thermal mass representing an infinitely thin surface of size “A”, and connections between individual thermal masses have distance lengths “d”, are massless and have the specific thermal conductivity “λ” so that the following is obtained for thermal impedance:
Zₜₕ=d/(λ*A)*{square root over ((d²+(a/(ω=d))²)}

Whereas quantity “ω” in the case of electric waves describes the angular frequency of the electrical voltage, here it describes the angular frequency of the temperature oscillation.

Since the physical properties “λ” and “a” appear independently of each other, it is also possible to calculate both quantities from one measurement cycle.

By transition from a finite number of thermal masses of area “A” and distance length “d” to infinitely many, infinitely thin flat layers connected to each other, the following standard equation for heat flow in a solid can be used:
∂T/∂t=a*∂²T/∂x²,
In which “T” is the temperature, “t” the time, “a” the thermal diffusivity as well as “∂x” being the infinitesimal value of the distance “d”. A determination equation for quantity “a” is therefore available so that quantity “λ” can also be determined from a =λ(cₚ˜ρ).

An analysis of the recorded temperature trends therefore permits determination of the significant specific cooking product quantities in the form of thermal conductivity λ and thermal diffusivity “a”. After these physical properties have been determined, it is prescribed in the method that the type of product to be cooked be determined by comparison with value pairs of said physical properties stored in a database. It can be prescribed in particular that, so to speak, in self-learning fashion, if no value pair corresponding to the measured pairs is present in the database, the database can be expanded by the user by the present type of product to be cooked. A situation is therefore achieved in which automatic determination of this “new” product to be cooked is possible by means of the method in future cooking processes and performance of a cooking process can be simplified and the quality of the result of the cooking process increased.

In other variants it can also be prescribed that via heat flow source 23 heat energy is exclusively supplied to the product to be cooked, for example, in cyclic positive fashion, or only a defined temperature jump is produced at the heat flow source 23. For evaluation of the temperature values recorded in reaction to such a temperature fluctuation it can be prescribed that, in addition to the heat conduction model just described, additional models using numerical programs can be used as a basis. In the alternative analysis methods for the temperature trends it can be considered, in particular, that the propagation of thermal waves is neither spherical nor cylindrical and also not flat and significant thermal derivatives and capacitances can be introduced to the product to be cooked through the cooking process sensor 1 itself. For compensation of these effects, methods can be used that exploit the deformation of waves in the instantaneous heat flow at the heat flow source 23 in order to determine the specific physical properties or cooking product quantities. In particular, such analysis methods use Fourier algorithms directly or in a modified form. In this manner, the analysis result can be further improved and, in particular, it is possible to design the heat flow source 23 more simply, in particular, by eliminating the device 27 for removing heat energy from the product to be cooked.

Another variant of a device usable in the disclosed method is now described with reference to FIG. 3 in the form of a cooking process sensor 1′. FIG. 3 is a partial cross-sectional view of the cooking process sensor 1′, according to which the cooking process sensor 1′ has a shaft 3′. In contrast to the cooking process sensor 1 depicted in FIGS. 1 and 2, the cooking process sensor 1′ has a simple tip 7′. As can be further gathered from FIG. 3, shaft 3′ of the cooking process sensor 1′ has three areas 31a, 31b and 31c, which have low thermal conductivity. Low thermal conductivity is understood here to mean that the thermal conductivity is low or negligible relative to the thermal conductivity of a product to be cooked (not shown) into which the cooking process sensor 1′ is introduced. A heat flow source 23′ with a device 25′ to supply heat energy to the product to be cooked, as well as a device 27′ to withdraw heat energy from the product to be cooked, are present within shaft 3′. Moreover, the cooking process sensor 1′ has two temperature sensors 17′ and 19′ spaced from each other in the longitudinal direction of shaft 3′. The temperature sensors 17′, 19′ are connected via lines 21′ and device 25′, 27′ of heat flow source 23′ via lines 29′ to an evaluation unit (not shown). In contrast to the cooking process sensor 1 depicted in FIGS. 1 and 2, a cyclically-flowing coolant or cyclically-heated fluid is supplied as heat transfer agent to devices 25′, 27′ via lines 20′. In particular, this is air or liquid.

As already described by means of cooking process sensor 1, a temperature variation is produced within a product to be cooked surrounding the cooking process sensor 1′ via the heat flow source 23′. The temperature waves resulting from this propagate through the product to be cooked, which means that different temperature trends can be acquired on the temperature sensors 17′, 19′. Because of the high thermal conductivity of shaft 3′ outside of areas 31a, 31b and 31c the temperature sensors 17′, 19′ have an effective spacing Y, i.e. the width of the area 31b arranged in-between. Because of this spacing Y, a phase difference or different amplitude response is obtained between the values recorded by sensors 17′, 19′, by means of which, as described above, the specific material quantities or cooking product quantities, thermal conductivity and thermal diffusivity, can be determined and conclusions drawn concerning the substance or type of product to be cooked.

In other advantageous variants of the device (not shown), it can be prescribed that the evaluation unit or the data memory be implemented in a portable device. The device so configured therefore represents a portable measurement device, which can be used to collect measured values of different types of substances or to determine a type of product to be cooked independently of the cooking process.

The features of the invention disclosed in the previous description, drawings and in the claims can be but are not necessarily essential both individually and in any combination for implementation of the invention in its different variants.

1. Method for determining at least one physical property in a product to be cooked, comprising:
generating a time-variable temperature field within the product to be cooked;
acquiring a plurality of first measured values in the product to be cooked, in which the first measured values comprise at least a first temperature value at a first position and at least a second temperature value at a second position separated from the first position;
picking-up at least a second measured value in and/or at the product to be cooked, selected from thermodynamic physical properties, electrical physical properties, elastic physical properties, and/or optical physical properties, and
determining at least a first physical property in the form of a susceptibility, thermal diffusivity and/or specific thermal conductivity, and a second physical property, chosen from a substance class and/or at least a specific-substance quantity, from the first and second measured values.

2. Method according to claim 1, wherein a predetermined amount of heat is supplied to and/or withdrawn from the product to be cooked at a third position to generate the time-variable temperature field.

3. Method according to claim 2, wherein the supply and/or withdrawal of the amount of the heat occur periodically.

4. Method according to claim 2, wherein a predetermined temperature jump is produced at the third position to produce the time-variable temperature field.

5. Method according to claim 2, wherein one of the first or second positions is identical to the third position.

6. Method according to claim 1, wherein by means of the first measured value, at least one of an amplitude response or a phase position of at least one temperature wave produced by the time-variable temperature field is determined at the first and second positions.

7. (canceled)

8. Method according to claim 1, wherein by means of the first physical property and/or the second measured value at least a second physical property is determined.

9. Method according to claim 8, wherein the second physical property is determined by extrapolation or iteration of the time trend of the physical property and/or the second measured value and/or by comparison of the physical property and/or the second measured value with at least one temporarily-stored comparison values.

10. Method according to claim 9, wherein the at least one temporarily-stored comparison value is at least temporarily stored before, during and/or after generation of the time-variable temperature field.

11. Method according to claim 8, wherein the first and/or the second measured value(s) and/or the first and/or the second physical property is fed to a control device for at least one heat flow source, at least a heating and/or cooling element interacting with a cooking space, at least a fan, at least a device for introduction of moisture into the cooking space and/or at least a device for removal of moisture from the cooking space.

12. Method according to claim 1, wherein the first and/or second measured value(s) is acquired by a cooking process sensor at least partially insertable into a product to be cooked and/or the time-variable temperature field is produced by at least one heat flow source.

13. Device, in the form of a cooking process sensor for determining at least one physical property in a product to be cooked, comprising:
at least one shaft that can be introduced at least partially into the product to be cooked, including a first temperature sensor arranged at a first site corresponding to a first position and a second temperature sensor arranged at a second site corresponding to a second position, and a heat flow source arranged at a third site corresponding to a third position.

14. Device according to claim 13, wherein a spacing (X,Y) between two of the first, second and third site is less than the geometric length of a temperature wave produced within the product to be cooked by a time-variable temperature field produced by the heat flow source.

15. Device according to claim 13, wherein heat conduction between the first, second and/or third site is at least partially reduced over the shaft.

16. Device according to claims 13, wherein the shaft has a fork-like free end having at least two prongs in which the first site is arranged in the first prong of the fork and the second site is arranged in the second prong of the fork.

17. Device according to claim 16, wherein the third site is arranged in one of the first prong, the second prong and a third prong of the fork.

18. Device according to claims 13, wherein the heat flow source comprises one of a device for supplying heat energy, and a device to remove heat energy.

19. Device according to claim 13, including at least one sensor unit in effective connection with the device, to acquire a measured value.

20. Device according to claim 13, including at least one evaluation, control and/or regulation unit connectable to the device.

21. Device according to claim 13; wherein the- device is designed as an integral component of a cooking appliance or as a portable hand-held device.

22. Device according to claim 13, further including a handle that can be used to insert the shaft into the product to be cooked.

23. Device according to claim 15 wherein the heat conduction between the first, second and/or third site is at least partially reduced over the shaft at one area of the shaft at least partially comprising a material with lower thermal conductivity than the product to be cooked between the first, second and/or third site.

24. Device according to claim 18, wherein the heat flow source includes at least one of an electric heating device, a device to conduct a heating fluid, a Peltier element or a device for conduction of a cooling fluid.

25. Device according to claim 18, wherein the heat flow source includes at least one of a device to conduct a heating fluid comprising one of a combustion gas, air, or water or a device for conduction of a cooling fluid comprising one of air, water, or nitrogen.

26. Device according to claim 19, wherein the at least one sensor unit is comprised by the device.

27. Device according to claim 20, wherein the at least one evaluation, control and/or regulation unit is enclosed by a cooking appliance for production, preparation and/or cooking of foods.

28. Device according to claim 20, wherein the at least one evaluation, control and/or regulation unit is connectable to a memory unit.

29. Method according to claim 3, wherein the supply and/or removal of the amount of the heat occur periodically as a result of heat being supplied to and withdrawn from the product to be cooked in alternation.

30. Method according to claim 1, wherein the susceptibility is an elastic susceptibility.

31. Method according to claim 1, wherein the at least one of the susceptibility, the thermal diffusivity and the specific thermal conductivity is determined using a heat conduction model and/or a Fourier transform algorithm.

32. Method according to claim 1, wherein at least the second measured value is a moisture value, an electrical conductivity, an elastic constant or a light-scattering capability.

33. Method according to claim 8, wherein the second physical property is one of a substance class, a specific physical quantity, a geometry of the product to be cooked, a density of the product to be cooked, a degree of ripening of the product to be cooked, a pH value of the product to be cooked, a consistency of the product to be cooked, a storage condition of the product to be cooked, a browning of the product to be cooked, a crust formation of the product to be cooked, a vitamin degradation of the product to be cooked, a measure of a formation of carcinogenic substances in the product to be cooked, an end point of the process and/or an energy consumption during the process.

34. Method according to claim 8, wherein the second physical property is one of a substance class indicating a type of product to be cooked, or a core temperature of the product to be cooked.

35. Method according to claim 8, wherein the second physical property is used to determine a heating trend prediction and/or to control the course of the process.

36. Method according to claim 11, wherein the first and/or the second measured value(s) and/or the first and/or the second physical property is used to control the cooking course and/or to achieve a predetermined cooking result.

37. Method according to claim 11, wherein the first and/or the second measured value(s) and/or the first and/or the second physical property is used to control the cooking course and/or to achieve a predetermined cooking result by regulating the temperature trend, the moisture content and/or the air movement in the cooking space.
